(19) United States
(12) Patent Application Publication
(10) Pub. No.: US 2009/0212024 A1
(43) Pub. Date: Aug. 27, 2009

(54) WELDING PROCESS

(75) Inventors: Roger Müller, Engelskirchen (DE); Johannes Fisch, Engelskirchen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Schmidt + Clemens GmbH + Co. KG, Lindlar (DE)

(21) Appl. No.: 12/161,880

(22) PCT Filed: Jan. 23, 2007
(86) PCT No.: PCT/EP2007/000539

§ 371 Date: Dec. 16, 2008

(30) Foreign Application Priority Data
Jan. 23, 2006 (DE) 10 2006 003 293.4
Jul. 22, 2006 (DE) 10 2006 033 992.4

(51) Int. Cl. B23K 31/02

(52) U.S. Cl. 219/61; 219/61.7

(57) ABSTRACT

A welding process for end connection of a first tube to a second tube along a circumferential joint by means of a weld bead, in which the first and the second tube are arranged with respect to one another in the position which is necessary for formation of the circumferential joint, a heat sink for the extraction of coolant is inserted into the first and/or the second tube such that the coolant emitted from it can cool at least one of the tubes in the area of the end to be welded, the tubes and a welding burner for production of the weld bead can be moved relative to one another along the circumferential joint and are welded by the welding burner, and the coolant is used at specific intervals.

The invention relates to a welding process, and in particular relates to the use of a welding process for welding stainless-steel tubes, tubes based on nickel, in particular tubes based on nickel with high carbon components, and centrifugally cast tubes.

When tubes are being welded to one another, in general either the welding burner is moved along the circumferential joint around the tube ends on a plane at right angles to the longitudinal axis of the tubes, with the tubes fixed, or the first and the second tube are rotated synchronously by means of appropriate configurations of the holders holding them under the welding burner, with the welding burner stationary, such that the welding burner can close the circumferential joint by means of a weld bead.

EP 0 884 126 B1 describes one possible procedure for production of the weld bead by means of a pivoting welding burner. The complicated process of arranging individual weld beads, which are produced only over circular arc segments on the workpiece, with varying direction control of the welding burner in a row as described in EP 0 884 126 B1 shows what complex measures are involved in order to produce a high-quality weld bead. In practice, the object is to achieve one or more of the following aims in this case: welding through the root, a small number of filling welds, good link between a first weld bead and the second weld bead, and as little change as possible to the structure of the tube material in the area adjacent to the weld bead.

Against this background, the invention is based on the object of proposing a welding process which allows economic welding, and in particular less complex welding from the hardware point of view, and in particular good welding of stainless-steel tubes, tubes based on nickel, tubes based on nickel with high carbon components, and centrifugally cast tubes.

The object is achieved by a welding process as claimed in the two independent claims 1 and 6. Advantageous refinements are specified in the dependent claims.

The invention is based inter alia on the aim of extraction of a coolant during welding, which coolant can cool at least one of the tubes in the area of the end to be welded, and of not extracting this coolant continuously during the welding process, but only at specific intervals. By way of example it is possible to provide for the purposes of a welding program for a root layer to be welded first of all, without this being cooled by the emission of coolant during the process. This results in the advantage that the coolant which is used in the interior of the tube/tubes does not force the resultant root layer from the inside outwards, thus resulting in an undesired bead shape. According to one such embodiment of the invention, the tube/tubes can then be cooled by the use of coolant for example for welding of the filling or covering layer which is applied to the root layer. The use of the coolant would accordingly be restricted, for example, to the specific time interval during which the covering layer is being welded.

The idea according to the invention of not using the coolant continuously but only in quite specific intervals can also be applied to other intervals. For example, the interval need not be defined in time, but can be defined as a function of the burner tip position, and/or the burner tip orientation. For example, it is possible to define in a control system that coolant will be used whenever the burner tip is in a specific position and/or orientation.

The invention is therefore based on the basic knowledge that the extraction of the coolant can be used specifically as a factor influencing the shape of the weld bead, that is to say for example it can be used for a specific shaping of the root layer (if one wishes to force this outward) or at specific positions on the welding burner, for example when the burner tip is arranged at the side of the tubes, so that it is possible to ensure that a desired bead shape is achieved even in this welding position. In addition to this knowledge that the coolant can be used as a deliberate shaping element for the bead shape, the restriction of the use of coolant according to the invention to specific time intervals offers the advantage of reduced coolant consumption. According to the invention, the coolant is accordingly not used constantly during the welding process, but only in specific intervals. The intervals may always be of the same length. The length of the time interval is, however, preferably varied by a control system, for example as a function of a selected welding program. This makes it possible to provide different cooling of the tube ends for different sections of the welding process, and therefore offers the advantage of further optimization of the coolant consumption.

The use of the coolant in specific time intervals can be controlled by the operator himself, for example by him opening and closing a supply valve. It is particularly preferable for the use of the coolant to be subjected to open-loop or even closed-loop control by means of an open-loop or closed-loop control system. Different welding programs can be stored in this open-loop or closed-loop control program, with each program having a specific associated sequence of specific intervals. The operator can then select the best welding program for this purpose, depending on the type of tubes to be welded, for example depending on the tube materials, the tube dimensions, the welding bead preparation or the like.

The tungsten inert gas (TIG) welding process, which is well known in its own right, is particularly preferably used as the welding process. It has been found that the advantages of the invention can be implemented particularly well in this process. The welding burner preferably has a barrier gas supply which can be configured both such that it moves with the burner and such that it is stationary. Furthermore, a wire supply can be provided for the welding material. Welding material can be supplied selectively while welding individual layers, or, for example, it is possible to weld a complete layer without supplying any welding material.

In the embodiments of the process according to the invention which have been described above and those which will be described in the following text, the first tube and the second tube are welded to one another at the end. In this case, the expression tube means not only the elongated body in the sense of the actual word “tube” but also a curved tube, the tubular junction piece of a T-piece or any other body which has an end area with an essentially annular cross section, in particular in the form of a circular ring.

The end surfaces of the tubes may be untreated or else may be subjected to weld bead preparation. For example, the end surfaces may be chamfered in order to produce a V-bead or other bead shapes. It is particularly preferable for the end surface to be partly at right angles to the tube axis and partly at an angle to the tube axis, for example such that the root layer is welded as an I-bead, and the covering layer or filling layer are welded as a V-bead.

When the tubes are arranged in the position necessary to form the circumferential joint, the tubes are in particular arranged such that as far as possible there are no transitions on the outer circumferences. The tubes to be welded frequently do not have an exact cross section in the form of a circular ring, and, for example, have slightly varying wall thicknesses and/or for example an external circumferential shape which is not the same as the internal circumferential shape, for example an elliptical external circumferential shape. Advantages are now achieved when the tubes are aligned with respect to one another such that the two external circumferences are aligned as well as possible. The tubes could admittedly, for example, also be aligned coaxially, but it is preferable for the external circumference to be used as the measure for alignment of the tubes with respect to one another. The tubes are particularly preferably aligned with respect to one another such that there is a minimal offset both on the inside and on the outside. The mutually aligned tubes can be connected to one another such that they cannot rotate with respect to one another by spot welding (“tacking”). This results in one tube also being rotated when the other is rotated. The expression circumferential joint also means the tube cross sections to be connected being placed against one another directly, for example in the form of a butt joint, even if no joint or only a minimal joint remains between the tube ends in this case.

With respect to the holding of the tubes, these embodiments as described above and in the following text can hold the tube such that it cannot rotate, for example in the holder of a rotary drive. However, it is particularly preferable for the holder to be in the form of a pure resting surface for the tube. For example, the resting surface may have a cross section in the form of a circular arc and may have rollers in this cross section on which the tube which has been inserted into the resting surface can roll when it is rotated around its tube axis. The holder which holds a tube is preferably designed such that it holds the tube in a raised, horizontal position. In particular, the holder acts on the outside of the tube. For the purposes of this invention, a holder for a tube may, however, also be understood to mean any other contact surface for a tube or roller contact surfaces for tubes (roller bands) or even contact surfaces on the ground.

According to a further fundamental aspect of the invention, the tubes are welded with a weld bead having a plurality of layers by means of the welding burner, with the welding burner being held in a first welding position in order to produce a first layer, and being held in a second welding position in order to produce a second layer. The first welding position differs from the second welding position with respect to the position of the burner tip with respect to a null position, in which the burner tip is arranged vertically above the upper apex point (dead center position) of the tubes, and/or with respect to the position of the longitudinal axis of the welding burner with respect to the horizontal. In this case, the expression “first layer” should be understood as meaning not only the root layer, since the knowledge according to the invention can also be applied to the sequence of other layers, for example to a first filling layer and a second filling layer, or to a filling layer and a covering layer

This offers the advantage that the individual layers can be produced using the optimum alignment of the welding burner for the welding of the respective layer. By way of example, it has been found that a root layer can be produced particularly advantageously with a burner tip which is located in a first welding position with a first layer and with a first alignment of the longitudinal axis while, for example, a covering layer or a filling layer is preferably produced using a different welding position. The burner tip is preferably held stationary in one welding position for production of one complete layer, in which case the expression a “complete layer” can also be understood as meaning slight overwelding. Once this first layer (including possible slight overwelding) has been produced, the welding process can be interrupted, and the welding burner can be moved to a second welding position.

In one preferred embodiment, the tubes and the welding burner are moved in a first direction relative to one another in order to produce the first layer, and are moved in the direction opposite the first direction in order to produce the second layer of the weld bead. This is because, depending on the layer to be welded and the welding position, it may be advantageous to move the tubes on the one hand in the form of a rising bead and on the other hand in the form of a falling bead relative to the welding burner.

In one preferred embodiment to the invention, the intended pivoting range for the burner can be reduced and the burner can now be moved only along a circular arc segment which is less than 180°. This makes it possible to avoid the very complex structures which provide for the burner to be pivoted along the complete circumferential joint, that is to say 360°. At the same time, this welding process allows different relative velocities to be selected between the tube and the burner. For example, the burner can be moved in one direction within its circular arc segment, and the tubes can be moved in the other direction by means of their holders (which are then driven), when this is advantageous for a specific circular arc segment, while it is possible in other circular arc segments to keep the tubes stationary, and to move only the burner in its circular arc segment.

The pivoting apparatus for the burner preferably has a holder in which the welding burner is held with its additional elements which may be provided. This holder can preferably be moved directly or by interposition of a holding arm along a slotted-link guide, for example a rail in the form of a circular arc, and can be held on it. In this case, the expression a rail means both a body which simulates a traditional rail body and any other body along whose surface the holder can complete a pivoting movement of the burner along the restricted circular arc segment, according to the invention, supported directly or indirectly.

The advantage of this aspect of the invention is in particular that a rail, as is provided as a guide for holding—need not be passed around the tubes forming a complete circle. Alternatively, when, as is likewise possible according to the invention, a pivoting arm is used as a support for holding the welding burner, this results in advantages because the pivoting arm need carry out only restricted movements in order to move the burner according to the invention along the circular arc segment. It is no longer necessary to design the pivoting arm such that it can completely surround the tubes to be welded.

According to a further aspect of the invention, the longitudinal axis of the burner is tilted about a tilting point from a first position to a second position by means of a tilting apparatus during the welding process. According to the invention, the burner can be moved in this tilted position along the circumferential joint in order to form the weld bead. In this case, the longitudinal axis of the burner is preferably tilted within the plane at right angles to the longitudinal axis of the tube, from the normal position aligned radially with respect to the tubes to a position at an angle to the radial direction of the tubes. It has been found that the weld bead can be produced better with a tilted burner. This is particularly true when the longitudinal axis of the burner is tilted beyond the upper dead center position in order to produce the weld bead. For example, the welding process according to the invention can be used to produce a weld bead by aligning the burner radially with respect to the tube at the upper dead center position, and then moving it downwards along a circular arc segment, during which process the degree of tilt of the longitudinal axis from the radial alignment can be changed during this downward movement.

In one preferred embodiment, the tilting point is provided in the region of the burner tip. It has been found that the control system for the welding process according to the invention can be programmed more easily if the burner tip is defined as a fixed point. For the control system, it is advantageous for the movement of the burner tip to be defined along the chosen circular arc segment, and for the tilting of the burner to be used as an additional effect, although this does not change the position of the burner tip on the circular arc segment.

In one preferred embodiment of the welding process, a rotary drive for one of the tubes which is held in one of the holders is rotated about its longitudinal axis in the clockwise direction and in the counterclockwise direction. This reversal of the rotation direction makes it possible to increase the relative movements between the burner tip and the two tubes to be welded. When individual weld beads are arranged in a row, this direction reversal likewise allows the starting point for the next weld bead to be reached quickly, because the direction reversal allows the shortest distance to be chosen from the end point of the just completed weld bead to the starting point for the next weld bead that is being started.

In one preferred embodiment, a heat sink which can cool the tube from the inside is inserted at least into one tube. A heat sink such as this makes it possible to pass cooling gas to the tube ends from the interior and therefore to achieve intermediate layer temperatures which result in only slight shrinkage in the region close to the weld bead, or for example to prevent or at least to reduce structure changes in the material of the tube in the region of the weld bead.

It is particularly preferable for the heat sink to have an outlet section with a least one outlet for a coolant and to have sealing lips which project from the heat sink and bound the outlet section. It is particularly preferable for the heat sink to be cylindrical and to have, as sealing lips, two annular disks which each bound the outlet section, which is provided on the envelope surface of the cylindrical heat sink, at the end. The sealing lips are preferably produced from elastic material, at least in their outer edge sections. The heat sink can therefore easily be pulled out of the tube after the welding process has been completed. This is because the heat sink is frequently pushed partially into the end area of the second tube, beyond the end area of the first tube, so that the outlet section is arranged underneath the circumferential joint. The elastic configuration of the sealing lip now makes it possible for the heat sink to be pulled out of the tubes even when the root of the weld bead projects into the interior of the connected tubes. If the sealing lip were not to be elastic in this area, then it could not be moved beyond the bead of the weld bead root. The sealing lips can preferably be designed to be interchangeable, in order to allow simple matching to different internal cross sections of the tubes to be welded.

The welding processes described above are used particularly preferably for welding stainless steel tubes, tubes based on nickel, tubes based on nickel with a high carbon component, and/or centrifugally cast tubes.

The invention will be explained in more detail in the following text with reference to a drawing, which illustrates only one exemplary embodiment to the invention, and in which:

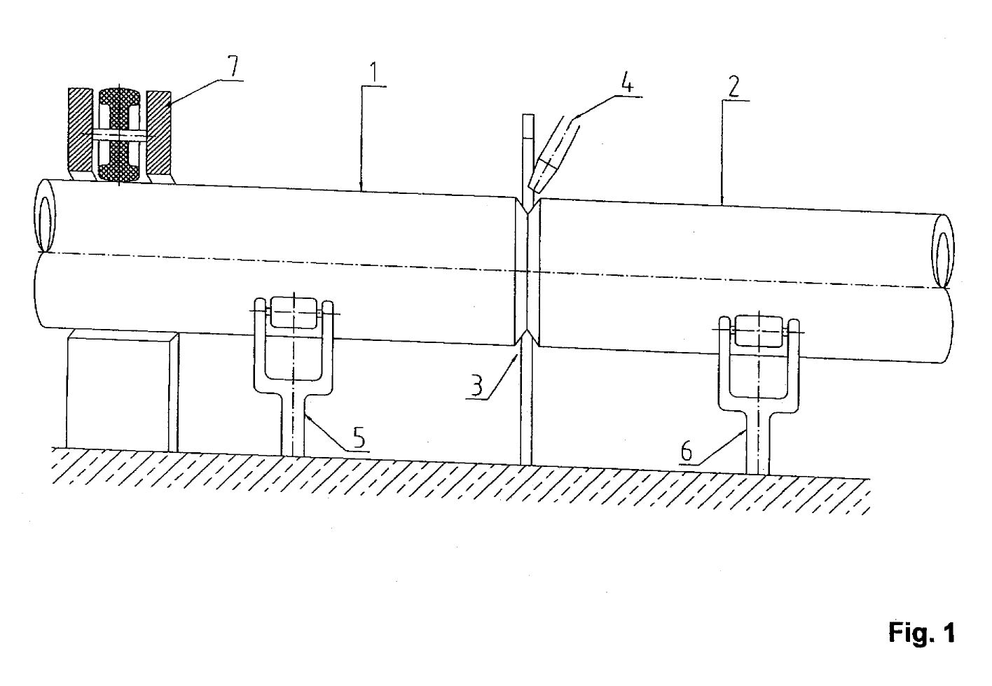

FIG. 1 shows a schematic side view of an apparatus on which the welding process according to the invention can be carried out;

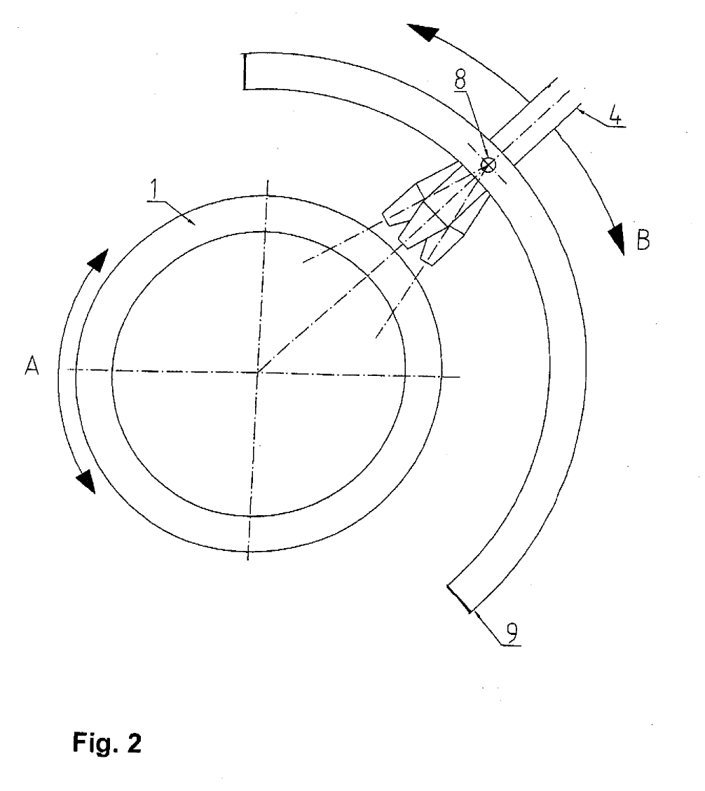

FIG. 2 shows a schematic plan view of the apparatus shown in FIG. 1, and

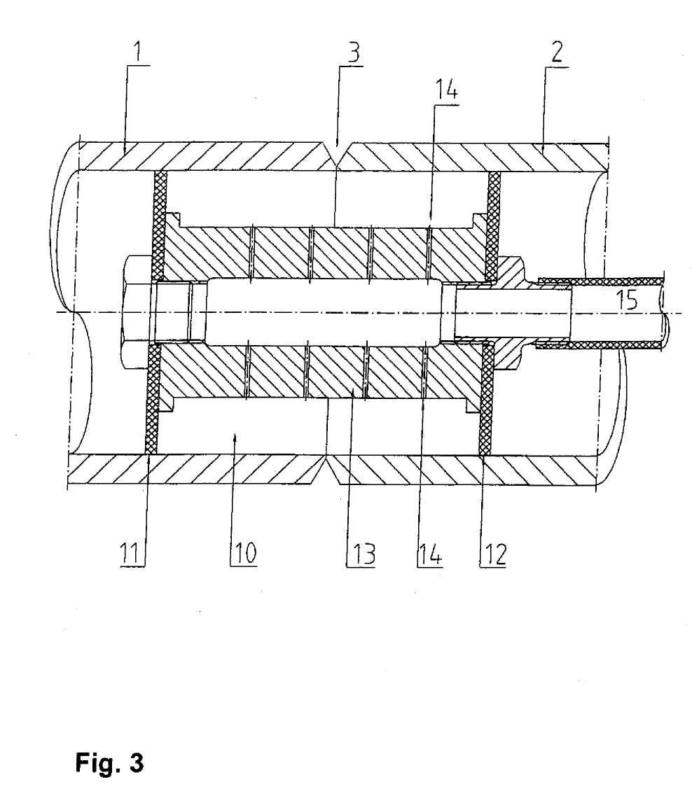

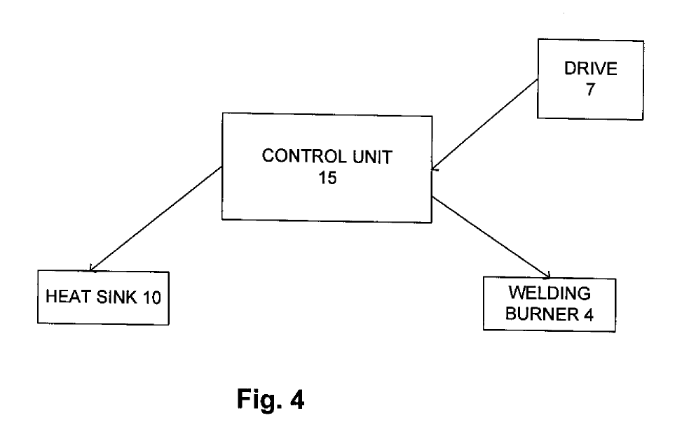

FIG. 3 shows a sectioned side view of a heat sink inserted into two tubes to be connected.

FIG. 1 shows a first tube 1 and a second tube 2, which are intended to be connected along a circumferential joint 3 by means of a weld bead. A welding burner 4 is provided for this purpose. The tubes 1, 2 lie on bearings 5, 6. A drive apparatus 7 is provided, in order to drive the tube 1 such that it rotates. The drive apparatus 7 is designed such that it can rotate the tube 1 in both the clockwise and anticlockwise directions, as illustrated by the double-headed arrow A in FIG. 2.

FIG. 2 shows details of the welding burner apparatus. The welding burner 4 can be tilted about a tilting point 8, in both directions of the double-headed arrow B, by means of a tilting apparatus which is not illustrated in any more detail. Tilting positions of the welding burner 4 are indicated by a relatively light dashed line in FIG. 2. Furthermore, the welding burner apparatus has a pivoting apparatus, which is not illustrated in more detail but by means of which the welding burner 4 can be moved along a circular arc segment 9. This circular arc segment is less than 180°.

FIG. 3 shows a heat sink 10 which is inserted into the tube 2 and the tube 1 such that it is arranged symmetrically with respect to the circumferential joint 3. The heat sink 10 has flexible sealing washers 11, 12. A cylindrical base body 13 has outlets 14 for a coolant, and these are connected to the base body 13 via a supply line 15.

In order to connect the first tube 1 to the second tube 2, the first and the second tube 1, 2 are arranged with respect to one another in the position that is necessary to form the circumferential joint 3, and they are placed on the bearings 5, 6 for this purpose. Furthermore, the tubes are positioned so as to achieve a good compromise between an offset on the outside and an offset on the inside. The aim is to minimize the offset on both sides. The tube 2 together with the tube 1 are then connected at the spot points by means of tacking, such that any rotary movement then produced by the drive apparatus 7 is transmitted from the tube 1 to the tube 2. Furthermore, the heat sink 10 is inserted into the tubes 1, 2 such that it is arranged symmetrically under the circumferential joint 3. The tube assembly comprising the tube 1 and the tube 2 is then rotated by means of the drive apparatus 7. The root layer of the weld bead that is to be produced is produced by the welding burner 4 during rotation. In order to produce the filling layer that follows this, the welding burner 4 is moved to a different position by means of the tilting apparatus and the pivoting apparatus. The tube assembly is rotated in the opposite direction, and the filling layer is welded using these settings. For this or a later filling layer, coolant is extracted via the heat sink. In this case, the use of the coolant is restricted to the interval of a tube rotation through 90°. The coolant supply for the further 90° rotation angle of the tube is then interrupted, and is then switched on again for 90°. Finally, the covering layer is welded. For this purpose, the welding burner 4 can once again be moved to a new tilting position and a new pivoted position. After completion of the welding process, the heat sink is pulled out of the tube assembly. The elastic configuration of the sealing lip allows the heat sink to be pulled out of the tubes even when the root of the weld bead projects into the interior of the connected tubes.

1.-21. (canceled)

22. A welding process for end connection of a first tube to a second tube along a circumferential joint by means of a weld bead, said method comprising the steps of:
arranging the first and second tubes in a relative position for allowing formation of the circumferential joint;
pushing a heat sink into at least one member selected from the group consisting of the first tube and the second tube;
moving the first and second tubes and a welding burner relative to one another along the circumferential joint for producing the weld bead and thereby weld the first and second tubes by the welding burner; and
emitting coolant from the heat sink at predefined intervals for cooling the member in an area of an end of the member as the first and second tubes are welded together.

23. The welding process of claim 22, wherein the emission of coolant at the specific time interval is controlled by a control system.

24. The welding process of claim 23, wherein the control system is configured to vary a length of a time interval.

25. The welding process of claim 22, further comprising the steps of holding the first tube in a first holder and holding the second tube in a second holder such as to form the circumferential joint between the first and second tubes.

26. The welding process of claim 25, wherein the moving step includes the step of rotating the first and second tubes past the welding burner during welding of the circumferential joint.

27. The welding process of claim 23, wherein the moving step includes the step of rotating the first and second tubes during welding and emitting coolant after every 90° rotation of the first and second tubes.

28. The welding process of claim 25, wherein the moving step includes the step of pivoting the welding burner at least partially along the circumferential joint by a pivoting apparatus, wherein the member is cooled in the area of its end to be welded by coolant released from the heat sink.

29. The welding process of claim 28, wherein the pivoting apparatus moves the welding burner with its burner tip along a circular arc segment of a circle which is substantially perpendicular to a longitudinal axis of the first and second tubes, with the circular arc segment being less than 180°.

30. The welding process of claim 25, wherein the welding burner is defined by a longitudinal axis which is tilted from a first position to a second position about a tilting point by means of a tilting apparatus in order to produce the weld bead.

31. The welding process of claim 30, wherein the tilting point is located in an area of a burner tip of the welding burner.

32. The welding process of claim 22, wherein at least one of the first and second tubes is rotatable in a clockwise direction and in a counterclockwise direction about its longitudinal axis by means of a rotary drive.

33. The welding process of claim 22, wherein the heat sink has an outlet section with at least one outlet for coolant, and sealing lips which project from the heat sink to bound the outlet section.

34. The welding process of claim 22, wherein the welding step is implemented by a tungsten inert gas (TIG) welding process.

35. The welding process of claim 22 for welding stainless-steel tubes, tubes based on nickel, tubes based on nickel with a high carbon component, and/or centrifugally cast tubes.

36. A welding process for end connection of a first tube to a second tube along a circumferential joint by means of a weld bead, said method comprising the steps of:
arranging the first and second tubes in a relative position for allowing formation of the circumferential joint; and
moving the first and second tubes and a welding burner relative to one another along the circumferential joint for producing the weld bead and thereby welding the first and second tubes with a plurality of layers of the weld bead by holding the welding burner in a first welding position to produce a first layer and holding the welding burner in a second welding position to produce a second layer,
wherein the first welding position differs from the second welding position with respect to a position of a burner tip in relation to a null position, in which the burner tip is arranged vertically above an uppermost apex point of the first and second tubes, and/or a position of a longitudinal axis of the welding burner with respect to the horizontal.

37. The welding process of claim 36, wherein the first and second tubes and the welding burner are moved in a first direction relative to one another to produce the first layer of the weld bead, and moved in a second direction in opposition to the first direction to produce the second layer of the weld bead.

38. The welding process of claim 36, wherein the welding step is implemented by a tungsten inert gas (TIG) welding process.

39. The welding process of claim 36, further comprising the step of inserting a heat sink at least into a member selected from the group consisting of the first tube and the second tube, for cooling the member.

40. The welding process of claim 36, further comprising the steps of holding the first tube in a first holder and holding the second tube in a second holder, with the first and second holders placing the first and second tubes in a relative position to allow formation of the circumferential joint, wherein in order to produce the weld bead the pivoting apparatus is able to move the welding burner with its burner tip along a circular arc segment of a circle which is substantially perpendicular to a longitudinal axis of the first and second tubes, with the circular arc segment being less than 180°.

41. The welding process of claim 40, wherein the welding burner is defined by a longitudinal axis which is tilted from a first position to a second position about a tilting point by means of a tilting apparatus, in order to produce the weld bead.

42. The welding process of claim 41, wherein the tilting point is located in an area of the burner tip.

43. The welding process of claim 36, wherein at least one of the first and second tubes is rotatable in a clockwise direction and in a counterclockwise direction about its longitudinal axis by means of a rotary drive.

44. The welding process of claim 39, wherein the heat sink has an outlet section with at least one outlet for coolant, and sealing lips which project from the heat sink to bound the outlet section.

45. The welding process of claim 36 for welding stainless-steel tubes, tubes based on nickel, tubes based on nickel with a high carbon component, and/or centrifugally cast tubes.

46. A heat sink for cooling a tube from the inside, comprising a base body having an axial end; and at least one elastic sealing lip extending radially from the end of the base body against the tube.

47. The heat sink of claim 46, wherein the base body has a cylindrical configuration and defined a longitudinal axis, said sealing lip being arranged on a plane perpendicular to the longitudinal axis of the base body.

48. The heat sink of claim 46, wherein the sealing lip is configured in the form of an annular disk.

49. The heat sink of claim 46, wherein the base body has an inlet port for introduction of a coolant into an interior of the base body, and at least one coolant outlet extending outwards from the interior of the base body for discharge of coolant.
